(19) United States
(12) Patent Application Publication
(10) Pub. No.: US 2004/0100148 A1
(43) Pub. Date: May 27, 2004

(54) Power control unit and vehicle-installed apparatus

(76) Inventors: Tsuyoshi Kindo, Sennan-gun (JP); Takeshi Hatakeyama, Neyagawa (JP); Akihiro Suzuki, Neyagawa (JP)

Correspondence Address: WENDEROTH, LIND & PONACK, L.L.P., 2033 K STREET N. W., SUITE 800, WASHINGTON, DC, 20006-1021, US

(21) Appl. No.: 10/688,879

(22) Filed: Oct. 21, 2003

(30) Foreign Application Priority Data
Oct. 23, 2002 (JP) 2002-308735

(51) Int. Cl. H02J 7/00

(52) U.S. Cl. 307/66

(57) ABSTRACT

When a user unlocks a door of the vehicle, a door unlocking detecting unit 118 transmits an unlocking signal to a power control unit 115. The power control unit 115, which has received the unlocking signal, uses a built-in secondary battery 119 to supply power to a CPU 111, and causes the CPU 111 to boot up a vehicle-installed apparatus 11. When the user gets in the vehicle and turns an ignition key ON, a key state detecting unit 117 notifies the power control unit 115 that the ignition key is turned ON, and the power control unit 115 switches a power supply from the built-in secondary battery 119 to a vehicle-installed battery 116. Thus, it is possible to provide a vehicle-installed system including a power control unit saving the user from the inconvenience of waiting for a vehicle-installed apparatus to perform an initial boot-up when he/she gets in the vehicle.

### BACKGROUND OF THE INVENTION

1. Field of the Invention

The present invention relates to power control units and vehicle-installed apparatuses. More particularly, the present invention relates to a power control unit and a vehicle-installed apparatus for controlling a power supply of a computer which obtains its power supply from a main power source during normal operation.

2. Description of the Background Art

Conventional techniques of a power control unit of the present invention are disclosed in, for example, Japanese Patent Laid-Open Publication No. 2000-172384 and Japanese Patent Laid-Open Publication No. H4-362898.

FIG. 8 is a block diagram showing the structure of a vehicle-installed apparatus disclosed in Japanese Patent Laid-Open Publication No. 2000-172384. A vehicle-installed apparatus 1000 shown in FIG. 8 includes a CPU 1011, a memory 1012, a storage device 1013, other logic 1014, a power control unit 1015, and a vehicle-installed battery 1016.

In the vehicle-installed apparatus 1000 shown in FIG. 8, an operation is performed by causing the CPU 1011 to read system data stored in the storage device 1013, and store temporal data in the memory 1012. The CPU 1011 receives an input from an input unit (not shown) for performing an operation, and outputs the results of the operation to a display unit (not shown). The above components are similar to such components as a CPU, etc., included in a typical computer. Note that the storage device 1013 is, for example, an HDD. Also, the other logic 1014 is, for example, an external input/output function such as a display or a keyboard.

Here, a power source for the vehicle-installed apparatus 1000 will be described. The vehicle-installed apparatus 1000 obtains two types of power supplies, one from an accessory power source (hereinafter, referred to as +ACC) and another from a continuous power source (hereinafter, referred to as +B) of the vehicle-installed battery 1016. When an ignition key is ON, the +B supplies a large amount of power to the vehicle-installed apparatus 1000. On the contrary, when the ignition key is OFF, +B supplies a small amount of power to the vehicle-installed apparatus 1000. The +ACC switches its ON/OFF in synchronization with an ON/OFF of the ignition key.

First, an operation performed by the vehicle-installed apparatus 1000 when a user turns the ignition key ON will be described.

When the user turns the ignition key ON, the power control unit 1015 detects that the +ACC is turned from OFF to ON, and uses the +ACC and the +B to supply power to the CPU 1011, the storage device 1013, and the other logic 1014. Next, the CPU 1011 performs an initial boot-up process and goes into normal operation. As a result, the vehicle-installed apparatus 1000 is booted up.

Next, an operation of the vehicle-installed apparatus 1000 when the user turns the ignition key OFF during boot-up of the vehicle-installed apparatus 1000 will be described.

When the user turns the ignition key OFF, the power control unit 1015 detects that the +ACC is turned from ON to OFF, and gives an end instruction to the CPU 1011. The CPU 1011 receives the end instruction and performs an end process, for example, by saving the contents of the memory 1012 to the storage device 1013. As a result, the vehicle-installed apparatus ends its operation.

As such, in general, the conventional vehicle-installed apparatus 1000 performs an initial boot-up process and an end process of the vehicle-installed apparatus 1000 in response to an ON/OFF switching of the +ACC.

Also, with regard to an electric apparatus such as a lamp or a horn loudspeaker which is likely to be operated even before the accessory power source (+ACC) is turned ON, a technique about a vehicle-installed multiplexing transmission device for effectively reducing the amount of current (+B current at the time of ignition-off) consumption by maintaining a wake-up state of the electric apparatus if there is a possibility that activation thereof is needed, and bringing a system of the electric apparatus down in an appropriate manner if there is no need for activation thereof is disclosed (for example, in Japanese Patent Laid-Open Publication No. H4-362898).

However, the above vehicle-installed apparatus 1000 encounters a problem in the case where the computer requires a long boot-up time. A boot-up time of the computer, which is normally booted up from an HDD of a PC, etc., varies according to a start/end state of an OS, but the computer usually takes several tens of seconds to be booted up from power ON.

For example, in the case where an OS of the vehicle-installed apparatus 1000 is in a so-called “end state” and an initial boot-up process and an end process are performed with every switching of an ON/OFF of the +ACC, the user has to wait for the vehicle-installed apparatus 1000 to be booted up every time he/she gets in a vehicle. Note that the “end state” is a state in which the contents of the active main memory of the vehicle-installed apparatus are cleared, and a power supply to all the devices from the CPU to peripheral devices is stopped. In the end state, a state of the OS during the last operation is not stored, and the vehicle-installed apparatus takes the longest boot-up time to be booted up.

Furthermore, with regard to a state of the OS of the vehicle-installed apparatus 1000, there are a “standby state” and a “hibernate state” along with the above “end state”. The “standby state” is a state in which power is supplied to the CPU 1011 and the memory 1012 of the vehicle-installed apparatus 1000, but a power supply to peripheral devices such as a monitor and the HDD, which require a considerable amount of power, is stopped. The “standby state” is similar to that of a standby state of Microsoft (R) Windows (R) Operating System. The “hibernate state” is a state in which the contents of the active memory 1012 of the vehicle-installed apparatus 1000 are saved in the HDD, etc., and a power supply to all the devices from the CPU to the peripheral devices is stopped. The “hibernate state” is similar to that of a hibernation state of Microsoft (R) Windows (R) Operating System. In the above “standby state” and “hibernate state”, a time to resume the vehicle-installed apparatus from power ON ranges from a few to a little over ten seconds, which is relatively short, whereby the user is less annoyed even if the initial boot-up process is performed after the +ACC is turned ON.

### SUMMARY OF THE INVENTION

Therefore, an object of the present invention is to provide a vehicle-installed system including a power control unit which saves the user from the inconvenience of waiting for the vehicle-installed apparatus 1000 to perform an initial boot-up when he/she gets in the vehicle.

Also, another object of the present invention is to provide a vehicle-installed system including a power control unit capable of performing fine-tuned power control in response to a state of the OS, such as a “hibernate state” or a “standby state”.

The present invention has the following features to attain the objects mentioned above.

A first aspect of the present invention is directed to a power control unit. In the power control unit according to the present invention, an auxiliary battery control section boots up the computer by starting a power supply from an auxiliary battery to a computer when an unlocking detecting section detects that the door is unlocked, and a power source switching section stops a power supply from the auxiliary battery and starts a power supply from a main power source when an ignition key detecting section detects that an ignition key is switched from OFF to ON during the power supply from the auxiliary battery.

Also, the auxiliary battery control section monitors an amount of power remaining in the auxiliary battery, and boots up the computer by starting a power supply from the auxiliary battery to the computer only when the unlocking detecting section detects that the door is unlocked and the amount of power remaining in the auxiliary battery is equal to or greater than a predetermined value.

Furthermore, a state determining section may determine a start and end state of the computer, and the auxiliary battery control section may boot up the computer by starting a power supply from the auxiliary battery to the computer only when the unlocking detecting section detects that the door is unlocked and the state determining section determines that the computer is in a state in which it is not capable to be booted up unless an initial boot-up is completed.

Also, the ignition key of the vehicle and the auxiliary battery control section may include authentication information for identifying a user of the vehicle. The vehicle may obtain the authentication information from the ignition key when it is detected that the door is unlocked. The auxiliary battery control section may boot up the computer by starting a power supply from the auxiliary battery to the computer only when the unlocking detecting section detects that the door is unlocked and the authentication information included in the auxiliary battery control section coincides with the authentication information obtained by the vehicle.

According to another aspect of the present invention, a time measuring section measures a predetermined time from when the unlocking/locking detecting section detects that the door is unlocked, and the auxiliary battery control section boots up the computer by starting a power supply from the auxiliary battery to the computer if the unlocking/locking detecting section does not detect that the door of the vehicle is locked while the time measuring section measures the predetermined time. Also, the power source switching section stops a power supply from the auxiliary battery and starts a power supply from the main power source when the ignition key detecting section detects that the ignition key is switched from OFF to ON during the power supply from the auxiliary battery.

According to still another aspect of the present invention, the auxiliary battery control section boots up the computer by starting a power supply from the auxiliary battery installed in the vehicle to the computer when a user detecting section detects that the user gets in the vehicle after the unlocking detecting section detects that the door is unlocked, and the power source switching section stops a power supply from the auxiliary battery and starts a power supply from the main power source when the ignition key detecting section detects that the ignition key is switched from OFF to ON during the power supply from the auxiliary battery.

Note that the present invention is also directed to a vehicle-installed apparatus to which the power control unit is applied.

In the present invention, an initial boot-up of the computer is started when the door of the vehicle is unlocked, whereby it is possible to save the user from the inconvenience of waiting for the computer, which requires a long initial boot-up time, to perform the initial boot-up.

Also, if the amount of power remaining in the auxiliary battery is equal to or smaller than the predetermined value, the computer is not booted up using unlocking of the door as a trigger, thereby preventing the computer from being booted up when the amount of power remaining in the auxiliary battery is small. As a result, it is possible to prevent the computer from being booted up needlessly.

Also, boot-up of the computer is performed only when the computer is in a state in which it is not capable to be booted up unless an initial boot-up is completed. That is, if the computer is in a standby mode or a hibernate mode, which requires a short waiting time, the computer is not booted up. As a result, it is possible to prevent the computer from performing a needless boot-up operation.

Furthermore, based on an authentication process, it is determined whether or not the computer is booted up, whereby an unauthorized user is not allowed to boot up the computer. As a result, it is possible to prevent the computer from being used by an unauthorized user.

Still further, the computer is not booted up using unlocking of the door as a trigger if unlocking and locking of the door is sequentially performed within a predetermined time. Thus, it is possible to prevent the computer from performing a needless boot-up operation in the case where the user locks the door immediately after he/she unlocks the door, for any reason, without getting in the vehicle.

Also, unless the user detecting section detects that the user gets in the vehicle after the door is unlocked, the computer is not booted up. Thus, it is possible to prevent the computer from performing a needless boot-up operation in the case where the user locks the door immediately after he/she unlocks the door, for any reason, without getting in the vehicle.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a vehicle-installed system including a power control unit according to a first embodiment of the present invention;

FIG. 2 is a flowchart showing an operation of the vehicle-installed system including the power control unit according to the first embodiment of the present invention;

FIG. 3 is a flowchart showing an operation of a vehicle-installed system including a power control unit according to a second embodiment of the present invention;

FIG. 4 is a block diagram showing a vehicle-installed system including a power control unit according to a third embodiment of the present invention;

FIG. 5 is a flowchart showing an operation of the vehicle-installed system including the power control unit according to the third embodiment of the present invention;

FIG. 6 is a block diagram showing another example of the vehicle-installed system including the power control unit according to the third embodiment of the present invention;

FIG. 7 is a flowchart showing another exemplary operation of the vehicle-installed system including the power control unit according to the third embodiment of the present invention; and

FIG. 8 is a block diagram showing the structure of a conventional vehicle-installed system.

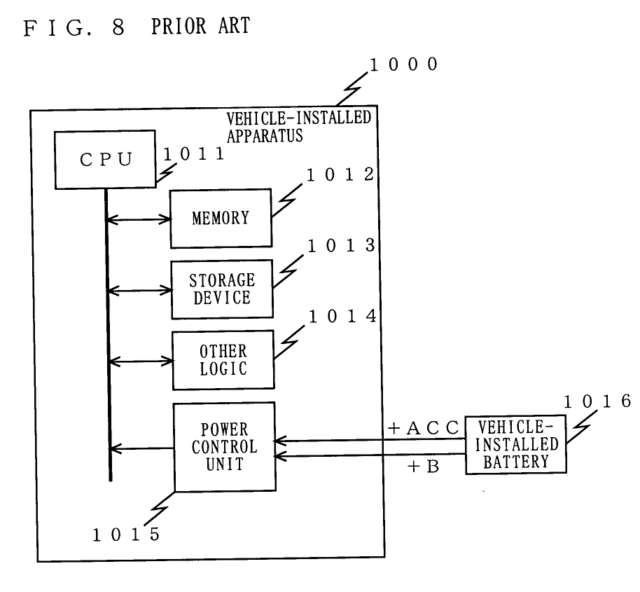

### DESCRIPTION OF THE PREFERRED EMBODIMENTS

(First Embodiment)

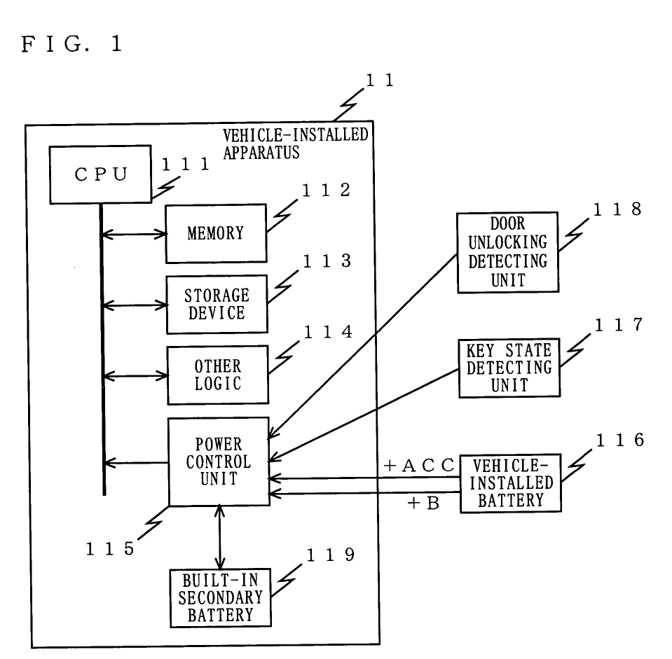

Hereinafter, a vehicle-installed system including a power control unit according to a first embodiment of the present invention will be described with reference to the drawing. FIG. 1 is a block diagram showing the vehicle-installed system including the power control unit according to the first embodiment of the present invention.

The vehicle-installed system shown in FIG. 1 includes a vehicle-installed apparatus 11, a vehicle-installed battery 116, a key state detecting unit 117, and a door unlocking detecting unit 118. The vehicle-installed apparatus 11 includes a CPU 111, a memory 112, a storage device 113, other logic 114, a power control unit 115, and a built-in secondary battery 119. Hereinafter, the structure of the vehicle-installed apparatus 11 will be described.

In the vehicle-installed apparatus 11 shown in FIG. 1, an operation is performed by causing the CPU 111 to read system data stored in the storage device 113, and store temporary data in the memory 112. The CPU 111 receives an input from an input unit and performs an operation, and outputs the results of the operation to a display unit. The above components are similar to a CPU, a storage device, and a memory, etc., included in a typical computer.

Here, power switching performed by the vehicle-installed battery 116 for the vehicle-installed apparatus 11 will be described. The vehicle-installed battery 116 supplies two types of power supplies, one from an accessory power source (hereinafter, referred to as +ACC) and another from a continuous power source (hereinafter, referred to as +B) to the vehicle-installed apparatus 11. When an ignition key is ON, the +B supplies a large amount of power to the vehicle-installed apparatus 11. On the contrary, when the ignition key is OFF, the +B supplies a small amount of power to the vehicle-installed apparatus 11. The +ACC switches its ON/OFF in synchronization with an ON/OFF of the ignition key. That is, when the ignition key is OFF, the +B supplies a small amount of power to the vehicle-installed apparatus 11, and the above small amount of power is not sufficient to operate the vehicle-installed apparatus 11. Thus, hereinafter, for the sake of the simplification of the descriptions, it is assumed that no power supply is performed from the +ACC and the +B (that is, a main power source) in the case where the ignition key is OFF.

The key state detecting unit 117 is a unit for making a notification about a state of the ignition key to the power control unit 115. In the present embodiment, the key state detecting unit 117 notifies the power control unit 115 that the ignition key is turned ON. The door unlocking detecting unit 118 is a unit for transmitting an unlocking signal indicating that a door is unlocked to the power control unit 115 when the door is unlocked. The above key state detecting unit 117 and the door unlocking detecting unit 118 can be realized by the units installed in a conventional typical vehicle. Note that, in the case where an engine of the vehicle is not started by means of the ignition key, what is needed is to provide the vehicle with a similar component, in place of the key state detecting unit, for notifying that the engine is started.

The power control unit 115 controls a power supply to the CPU 111 and the memory 112, etc., and includes an MPU, for example. More specifically, in response to the unlocking signal from the door unlocking detecting unit 118, the power control unit 115 causes the built-in secondary battery 119 to supply power to the CPU 111, etc., and switches a power source from the built-in secondary battery 119 to the vehicle-installed battery 116 in response to the notification, from the key state detecting unit 117, that the ignition key is turned ON.

An operation of the vehicle-installed system structured as described above will be described below. Note that respective processes described in the present embodiment can be realized utilizing the computer and software, or utilizing a hardware circuit dedicated to the respective processes.

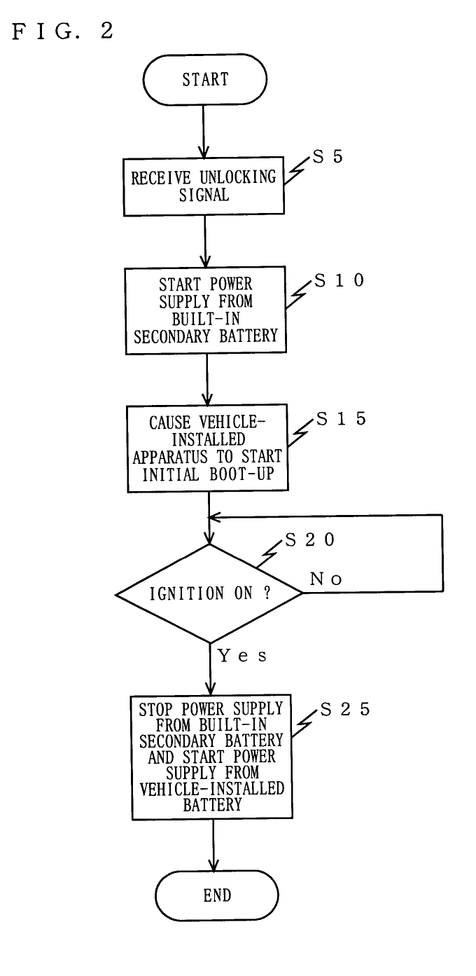

Hereinafter, with reference to the drawing, the operation of the vehicle-installed system according to the present embodiment is described. FIG. 2 is a flowchart showing the operation performed by the vehicle-installed system according to the present embodiment when the user gets in the vehicle.

First, the user unlocks the door of the vehicle using a keyless entry system, etc., of the vehicle. When the door of the vehicle is unlocked, the door unlocking detecting unit 118 transmits an unlocking signal to the power control unit 115. Then, the power control unit 115 receives the unlocking signal (step S5).

The power control unit 115, which has received the unlocking signal, causes the built-in secondary battery 119 to start a power supply to the CPU 111, the memory 112, the storage device 113, and the other logic 114 (step S10). Next, the power control unit 115 gives an instruction to the CPU 111 to start an initial boot-up of the vehicle-installed apparatus 11 (step S15). Thus, the initial boot-up of the vehicle-installed apparatus 11 is started, and the vehicle-installed apparatus 11 goes into normal operation.

Next, the power control unit 115 determines whether or not the notification that the ignition key is turned ON is made by the key state detecting unit 117 (step S20). Here, if the user gets in the vehicle and turns the ignition key ON, the process proceeds to step S25. On the other hand, if the ignition key is not turned ON, the process goes back to step S20. Note that, if the ignition key is not turned ON, step S20 is repeated until the ignition key is turned ON.

If the notification is made that the ignition key is turned ON, the power control unit 115 stops a power supply from the built-in secondary battery 119, and supplies power of the +ACC and the +B from the vehicle-installed battery 116 to the CPU 111, etc (step S25). Thus, a normal power supply is started by the vehicle-installed battery 116.

As such, in the vehicle-installed system according to the present embodiment, an initial boot-up of the vehicle-installed apparatus 11 is started when the door of the vehicle is unlocked. Thus, compared to the conventional vehicle-installed apparatus whose initial boot-up is started after the user gets in the vehicle and turns the ignition key ON, the vehicle-installed system according to the present embodiment allows the user to wait for a shortened time before the initial boot-up is completed.

Note that, in the vehicle-installed system according to the present embodiment, when a power supply is switched from the built-in secondary battery 119 to the vehicle-installed battery 116 at step S25, the power control unit 115 may perform control to charge the built-in secondary battery 119.

Note that, in the event of a voltage sag of the +B during normal operation of the vehicle-installed apparatus 11, a sudden reset may be avoided by compensating for the voltage sag by a power supply from the built-in secondary battery 119.

Note that, in the vehicle-installed system according to the present embodiment, the power control unit 115 may have an authentication mechanism. Specifically, authentication information of a user name and a password is embedded in a door unlocking key and the power control unit 115. When the user unlocks the door, the above authentication information is transmitted from the door unlocking key to the door unlocking detecting unit 118. The door unlocking detecting unit 118 embeds the authentication information in an unlocking signal, and outputs the unlocking signal to the power control unit 115. The power control unit 115, which has received the unlocking signal, determines whether or not the user name and the password coincide with the stored user name and password, by ref erring to the authentication information of the unlocking signal. Here, if the user name and the password coincide with the stored user name and password, the power control unit 115 starts the vehicle-installed apparatus 11. On the other hand, if the user name and the password do not coincide with the stored user name and password, the power control unit 115 does not start the vehicle-installed apparatus 11. Thus, it is possible to prevent the vehicle-installed apparatus 11 from being used by an unauthorized user. Furthermore, in the case where an authorized user uses the vehicle-installed apparatus 11, it is also possible to cause the display unit of the vehicle-installed apparatus 11 to display a desktop customized to the user. Note that it is assumed that the authentication information includes a user name and a password, but it is not limited thereto.

Here, in the vehicle-installed system according to the present embodiment, it is assumed that power is supplied to the CPU 111, etc., from the built-in secondary battery 119 when the power control unit 115 receives the unlocking signal. However, if the amount of power remaining in the built-in secondary battery 119 is small, it is not possible to boot up the vehicle-installed apparatus 11 even if the door is unlocked. In this case, even if the vehicle-installed apparatus 11 is booted up, the built-in secondary battery 119 cannot supply power until the user turns the ignition key ON. Thus, in a second embodiment, which will be described below, a vehicle-installed system in which the power control unit 115 is capable of controlling a power supply from the built-in secondary battery 119 according to the amount of power remaining in the built-in secondary battery 119 will be described.

(Second Embodiment)

Hereinafter, the vehicle-installed system including a power control unit according to the second embodiment will be described with reference to the drawing.

The structure of the vehicle-installed system according to the present embodiment is also shown in FIG. 1, as is the case with the vehicle-installed system according to the first embodiment, and therefore is not further described herein. However, the vehicle-installed system according to the present embodiment differs from the vehicle-installed system according to the first embodiment in an operation of the power control unit 115.

Here, a state of the OS of the vehicle-installed system will be described. The OS of the vehicle-installed system has the following three states: an “end state”, a “standby state”, and a “hibernate state”. In the end state, the vehicle-installed apparatus 11 is not booted up unless an initial boot-up is performed. In the standby state and the hibernate state, it is possible to immediately resume the vehicle-installed apparatus 11 without the initial boot-up. Note that the respective states have been described in detail in the conventional technique, and therefore are not further described.

Hereinafter, an operation of the above vehicle-installed system will be described. Note that respective processes described in the present embodiment can be realized utilizing the computer and software, or utilizing a hardware circuit dedicated to the respective processes.

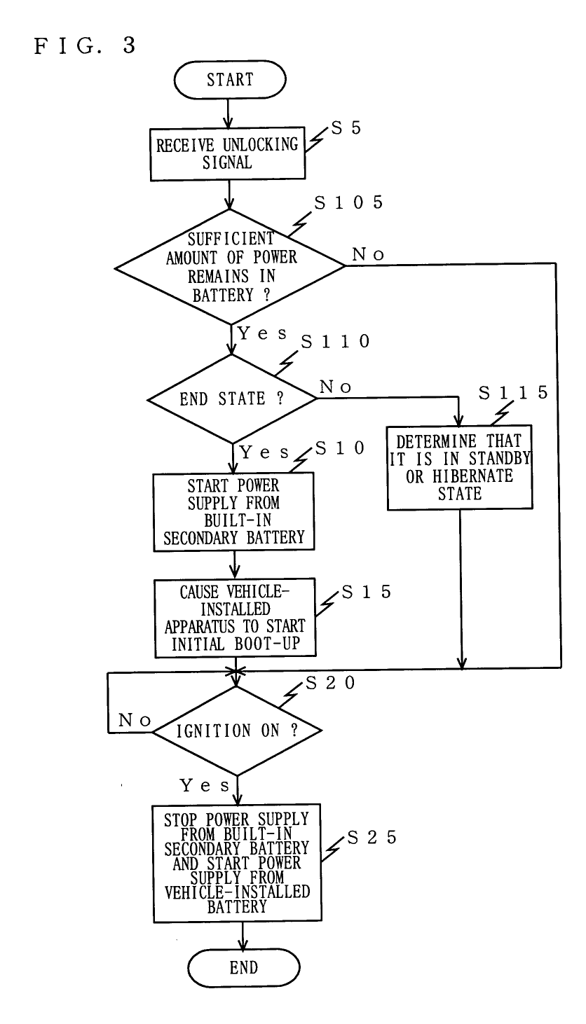

Hereinafter, the operation of the vehicle-installed system according to the present embodiment will be described with reference to the drawing. FIG. 3 is a flowchart showing the operation performed by the vehicle-installed system according to the present embodiment when the user gets in the vehicle.

First, a procedure from a step in which the user unlocks the door to a step (step S5) in which the power control unit 115 receives the unlocking signal is similar to the corresponding procedure of the first embodiment, and therefore is not further described herein.

The power control unit 115, which has received the unlocking signal, refers to the amount of power remaining in the built-in secondary battery 119, and determines whether or not the remaining amount of power is greater than a predetermined amount (step S105). Note that the predetermined amount of power remaining in the battery is an amount of power necessary for the built-in secondary battery 119 to maintain a driving state of the vehicle-installed apparatus 11 within a period of time in which the power control unit 115 receives the unlocking signal and then receives the notification of ignition ON. If the amount of power remaining in the battery is equal to or greater than the predetermined amount, the process proceeds to step S110. On the other hand, if the amount of power remaining in the battery is not equal to or greater than the predetermined amount, the process proceeds to step S20.

If the amount of power remaining in the battery is not equal to or greater than the predetermined amount, the vehicle-installed apparatus 11 is booted up or resumed using the fact that the ignition key is turned ON as a trigger, and it is not booted up or resumed using unlocking of the door as a trigger. Then, the process proceeds to step S20.

On the other hand, if the amount of power remaining in the battery is equal to or greater than the predetermined amount, the power control unit 115 determines whether or not the vehicle-installed apparatus 11 is in the end state (step S110). If the vehicle-installed apparatus 11 is in the end state, the process proceeds to step S10. On the other hand, if the vehicle-installed apparatus 11 is not in the end state, the process proceeds to step S115.

If the vehicle-installed apparatus 11 is not in the end state, the power control unit 115 determines that the vehicle-installed apparatus 11 is either in the standby state or in the hibernate state (step S115). In this case, it is possible to resume the vehicle-installed apparatus 11 in a short time without the initial boot-up. Thus, the vehicle-installed apparatus 11 is resumed using the fact that the ignition key is turned ON as a trigger, and it is not resumed using unlocking of the door as a trigger. Then, the process proceeds to step S20.

Note that the operations performed in steps S10 through S25 are the same as steps S10 through S25, and therefore are not further described.

The vehicle-installed system according to the present embodiment allows the user to wait for a shortened time before the initial boot-up of the vehicle-installed apparatus is completed, as is the case with the first embodiment.

Also, in the vehicle-installed system according to the present embodiment, power control is performed in accordance with the amount of power remaining in the built-in secondary battery 119 of the vehicle-installed apparatus 11, whereby it is possible to prevent the vehicle-installed apparatus 11 from being shut down if the built-in secondary battery 119 goes dead during a time period after the door is unlocked until the ignition key is turned ON.

Furthermore, in the vehicle-installed system according to the present embodiment, a power supply from the built-in secondary battery 119 is controlled in accordance with the state of the vehicle-installed apparatus 11, thereby preventing the built-in secondary battery 119 from being wasted. As a result, it is possible to prolong the life of the built-in secondary battery 119.

Now, the user may lock the door, immediately after he/she unlocks the door, without getting in the vehicle in order to return home, for example, for fetching something left behind. In this case, even though the user does not get in the vehicle, the vehicle-installed systems according to the first and second embodiments start an initial boot-up of the vehicle-installed apparatus 11, which is a needless operation.

Thus, as a third embodiment, a vehicle-installed system by which the above needless initial boot-up is not performed will be described below.

(Third Embodiment)

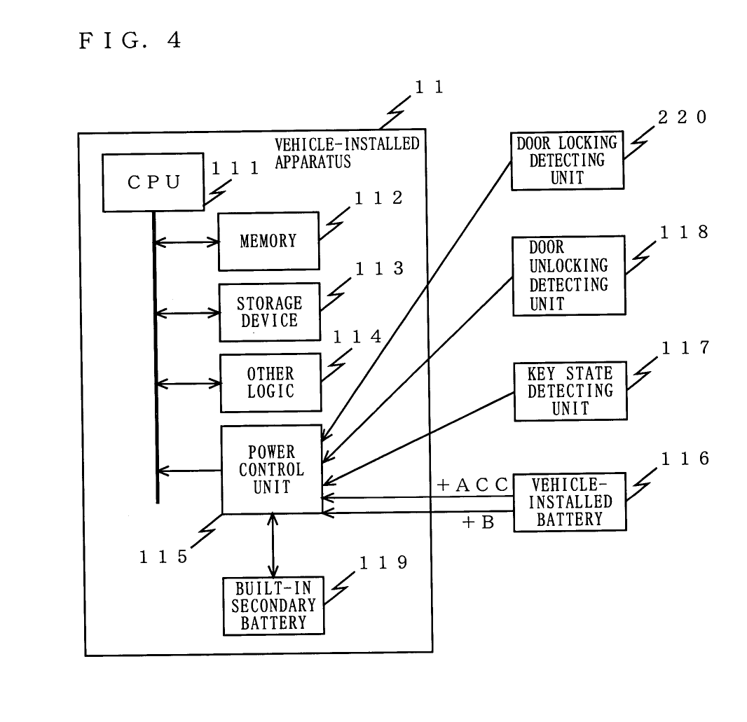

Hereinafter, the vehicle-installed system including a power control unit according to the third embodiment of the present invention will be described with reference to the drawing. FIG. 4 is a block diagram showing the vehicle-installed system according to the third embodiment of the present invention.

The vehicle-installed system shown in FIG. 4 includes the vehicle-installed apparatus 11, the vehicle-installed battery 116, the key state detecting unit 117, the door unlocking detecting unit 118, and a door locking detecting unit 220. The vehicle-installed system according to the present embodiment differs from the vehicle-installed system according to the first embodiment in that the door locking detecting unit 220 is included. Note that other components are basically similar to those described in the first embodiment, and therefore the description thereof is omitted.

Here, the above door locking detecting unit 220 is described. The door locking detecting unit 220 transmits, to the power control unit 115, a locking signal indicating that a door is locked when the door is locked. Note that the door locking detecting unit 220 can be realized by a unit installed in a conventional typical vehicle.

An operation of the vehicle-installed system as described above will be described. Note that respective processes described in the present embodiment can be realized utilizing the computer and software, or utilizing a hardware circuit dedicated to the respective processes.

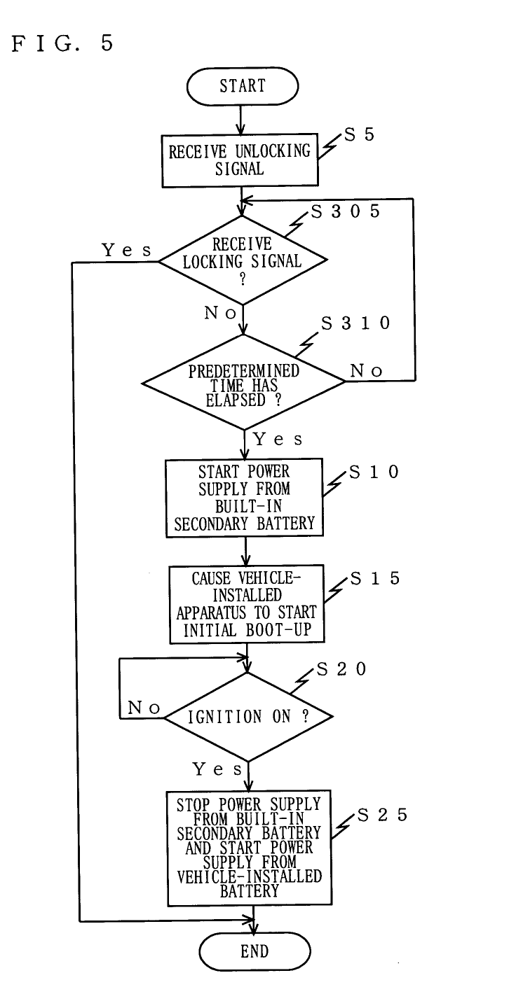

Hereinafter, the operation of the vehicle-installed system according to the present embodiment will be described with reference to the drawing. FIG. 5 is a flowchart showing the operation performed by the vehicle-installed system according to the present embodiment when the user gets in the vehicle.

First, a procedure from a step in which the user unlocks the door to a step (step S5) in which the power control unit 115 receives the unlocking signal is similar to the corresponding procedure of the first embodiment, and therefore is not further described herein.

The power control unit 115, which has received the locking signal, determines whether or not the locking signal is received from the door locking detecting unit 220 (step S305). Here, if the locking signal is received at step S305, the power control unit 115 determines that unlocking and locking are sequentially performed in a short time, and the process is ended without starting the vehicle-installed apparatus 11. On the other hand, if the locking signal is not received, the process proceeds to step S310.

If the locking signal is not received, the power control unit 115 determines whether or not a predetermined time has elapsed after reception of the unlocking signal (step S310). Note that the predetermined time is preferably considered to be a time generally required by the user to unlock the door and get in the vehicle. If the predetermined time has elapsed, the process proceeds to step S10, and the vehicle-installed apparatus 11 receives a power supply from the built-in secondary battery 119 and starts an initial boot-up. On the other hand, if the predetermined time has not elapsed, the process goes back to step S305. If the predetermined time has not elapsed, steps S305 and S310 are repeated until the locking signal is received at step S305 or the predetermined time has elapsed at step S310.

If the predetermined time has elapsed at step S310, the process proceeds to step S10, and the vehicle-installed apparatus 11 obtains a power supply from the built-in secondary battery 119 and starts an initial boot-up. Note that steps S10 through S25 are the same as steps S10 through S25 shown in FIG. 2 of the first embodiment, and therefore the description thereof is omitted.

As such, the vehicle-installed system according to the present embodiment allows the user to wait for a shortened time before the initial boot-up is completed, as is the case with the first embodiment.

Also, in the vehicle-installed system according to the present embodiment, if the power control unit 115 receives the locking signal within a predetermined time after reception of the unlocking signal, the vehicle-installed apparatus 11 is not booted up using the unlocking signal as a trigger. Thus, in the case where the user locks the door immediately after he/she unlocks the door, for any reason, without getting in the vehicle, it is possible to prevent a needless boot-up of the vehicle-installed apparatus 11.

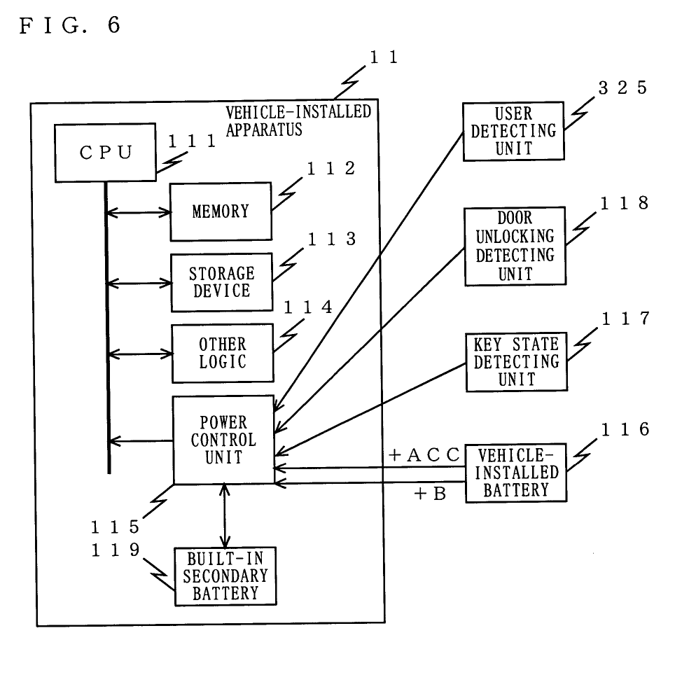

Note that, in the vehicle-installed system according to the present embodiment, it is assumed that the user does not get in the vehicle if unlocking and locking of the door is sequentially performed. However, a method for determining whether or not the user gets in the vehicle is not limited thereto. Specifically, in the vehicle-installed system according to the present embodiment, it is possible to include a user detecting unit 325 in place of the door locking detecting unit 220, as shown in FIG. 6, and cause the user detecting unit 325 to determine whether or not the user gets in the vehicle.

Here, the user detecting unit 325 detects whether or not the user is sitting in the seat of the vehicle. Specifically, the user detecting unit 325 determines that the user is sitting in the seat of the vehicle if it detects that the seatbelt is used, and transmits a signal indicating that the user is sitting in the seat to the power control unit 115. Note that a user detecting method is not limited thereto. For example, a person' weight may be detected by a sensor placed on the seat, or a presence of a person may be detected using infrared rays.

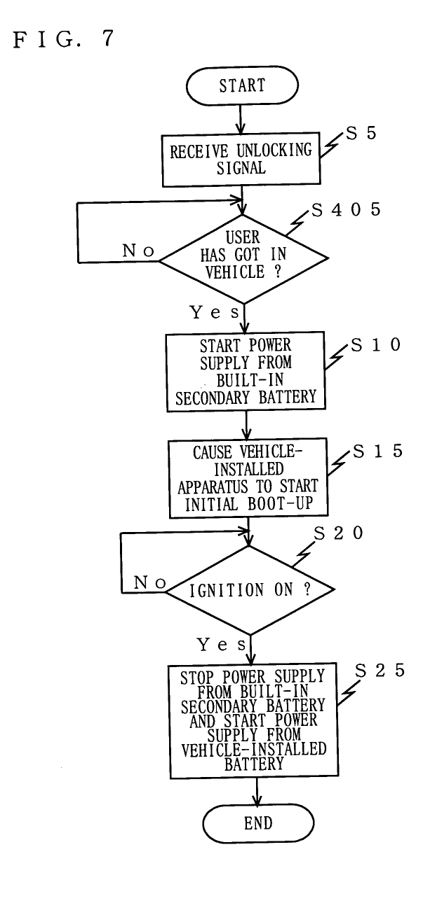

Now, an operation of the vehicle-installed system shown in FIG. 6 will be described with reference to the drawing. FIG. 7 is a flowchart showing the operation performed by the vehicle-installed system shown in FIG. 6 when the user gets in the vehicle.

The flowchart shown in FIG. 7 differs from the flowchart shown in FIG. 5 only in that step S405 is added in place of steps S304 and S310, and therefore the description thereof is omitted.

The power control unit 105, which has received a unlocking signal at step S5, determines whether or not the user gets in the vehicle (step S405). The determination is made based on whether or not a signal indicating that the user is sitting in the seat is transmitted to the power control unit 105 from the user detecting unit 325. If the user gets in the vehicle, the process proceeds to step S10. On the other hand, if the user does not get in the vehicle, the process goes back to step S405.

Note that, in the vehicle-installed system according to the first to third embodiments, the power control unit 115 determines that the ignition is turned ON based on the notification from the key state detecting unit 117, but the power control unit 115 may determine that the ignition is turned ON based on a start of a power supply from the +B. More specifically, the power control unit 115 may determine whether or not a power supply from the +B is started at step S20 of FIGS. 2, 3, 5, and 7. Furthermore, at step S25, what is needed for the power control unit 115 is to stop a power supply from the built-in secondary battery 119. Note that, in the case where the power control unit 115 monitors a power supply from the +B, the key state detecting unit is not needed.

Note that, in the vehicle-installed system according to the first to third embodiments, the door is unlocked using the key less entry system, but a door unlocking method is not limited thereto. The door unlocking method may be, for example, a smart entry system. Also, in place of user authentication using authentication information embedded in the ignition key, user authentication using biometric information (fingerprints, voice prints, irises, veins, or feature data obtained from features of a user) may be performed. Furthermore, the door may be unlocked by a system in which the smart entry system and the biometric information are combined.

While the invention has been described in detail, the foregoing description is in all aspects illustrative and not restrictive. It is understood that numerous other modifications and variations can be devised without departing from the scope of the invention.

What is claimed is:

1. A power control unit for controlling a power supply of a computer, which operates by obtaining a power supply from a main power source during normal operation, in a vehicle including an unlocking detecting section for detecting whether or not a door of the vehicle is unlocked, an ignition key detecting section for detecting whether or not an ignition key is switched from ON to OFF, and an auxiliary battery, comprising:
an auxiliary battery control section for booting up the computer by starting a power supply from the auxiliary battery to the computer when the unlocking detecting section detects that the door is unlocked; and
a power source switching section for stopping a power supply from the auxiliary battery and starting a power supply from the main power source when the ignition key detecting section detects that the ignition key is switched from OFF to ON during the power supply from the auxiliary battery.

2. The power control unit according to claim 1, wherein the auxiliary battery control section monitors an amount of power remaining in the auxiliary battery, and boots up the computer by starting a power supply from the auxiliary battery to the computer only when the unlocking detecting section detects that the door is unlocked and the amount of power remaining in the auxiliary battery is equal to or greater than a predetermined value.

3. The power control unit according to claim 1, further comprising a state determining section for determining a start and end state of the computer, wherein
the auxiliary battery control section boots up the computer by starting a power supply from the auxiliary battery to the computer only when the unlocking detecting section detects that the door is unlocked and the state determining section determines that the computer is in a state in which it is not capable to be booted up unless an initial boot-up is completed.

4. The power control unit according to claim 1, wherein
the ignition key of the vehicle and the auxiliary battery control section include authentication information for identifying a user of the vehicle,
the vehicle obtains the authentication information from the ignition key when it is detected that the door is unlocked, and
only when the unlocking detecting section detects that the door is unlocked and the authentication information included in the auxiliary battery control section coincides with the authentication information obtained by the vehicle, the auxiliary battery control section boots up the computer by starting a power supply from the auxiliary battery to the computer.

5. A power control unit for controlling a power supply of a computer, which operates by obtaining a power supply from a main power source during normal operation, in a vehicle including an unlocking/locking detecting section for detecting whether or not a door of a vehicle is unlocked/locked, an ignition key detecting section for detecting whether or not an ignition key is switched from ON to OFF, and an auxiliary battery, comprising:
a time measuring section for measuring a predetermined time from when the unlocking/locking detecting section detects that the door is unlocked;
an auxiliary battery control section for booting up the computer by starting a power supply from the auxiliary battery to the computer if the unlocking/locking detecting section does not detect that the door of the vehicle is locked while the time measuring section measures the predetermined time; and
a power source switching section for stopping a power supply from the auxiliary battery and starting a power supply from the main power source when the ignition key detecting section detects that the ignition key is switched from OFF to ON during the power supply from the auxiliary battery.

6. A power control unit for controlling a power supply of a computer, which operates by obtaining a power supply from a main power source during normal operation, in a vehicle including an unlocking detecting section for detecting whether or not a door of the vehicle is unlocked, an ignition key detecting section for detecting whether or not an ignition key is switched from ON to OFF, an auxiliary battery, and a user detecting section for detecting whether or not a user gets in the vehicle, comprising:
an auxiliary battery control section for booting up the computer by starting a power supply from the auxiliary battery installed in the vehicle to the computer when the user detecting section detects that the user gets in the vehicle after the unlocking detecting section detects that the door is unlocked; and
a power source switching section for stopping a power supply from the auxiliary battery and starting a power supply from the main power source when the ignition key detecting section detects that the ignition key is switched from OFF to ON during the power supply from the auxiliary battery.

7. A vehicle-installed apparatus for controlling a power supply of a computer, which operates by obtaining a power supply from a main power source during normal operation, in a vehicle including an unlocking detecting section for detecting whether or not a door of the vehicle is unlocked and an ignition key detecting section for detecting whether or not an ignition key is switched from ON to OFF, comprising:
an auxiliary battery;
an auxiliary battery control section for booting up the computer by starting a power supply from the auxiliary battery to the computer when the unlocking detecting section detects that the door is unlocked; and
a power source switching section for stopping a power supply from the auxiliary battery and starting a power supply from the main power source when the ignition key detecting section detects that the ignition key is switched from OFF to ON during the power supply from the auxiliary battery.

8. A vehicle-installed apparatus for controlling a power supply of a computer, which operates by obtaining a power supply from a main power source during normal operation, in a vehicle including an unlocking/locking detecting section for detecting whether or not a door of the vehicle is unlocked/locked and an ignition key detecting section for detecting whether or not an ignition key is switched from ON to OFF, comprising:
an auxiliary battery;
a time measuring section for measuring a predetermined time from when the unlocking/locking detecting section detects that the door is unlocked;
an auxiliary battery control section for booting up the computer by starting a power supply from the auxiliary battery to the computer if the unlocking/locking section does not detect that the door of the vehicle is locked while the time measuring section measures the predetermined time; and
a power source switching section for stopping a power supply from the auxiliary battery and starting a power supply from the main power source when the ignition key detecting section detects that the ignition key is switched from OFF to ON during the power supply from the auxiliary battery.

9. A vehicle-installed apparatus for controlling a power supply of a computer, which operates by obtaining a power supply from a main power source during normal operation, in a vehicle including an unlocking detecting section for detecting whether or not a door of the vehicle is unlocked, an ignition key detecting section for detecting whether or not an ignition key is switched from ON to OFF, and a user detecting section for detecting whether or not a user gets in the vehicle, comprising:
an auxiliary battery;
an auxiliary battery control section for booting up the computer by starting a power supply from the auxiliary battery to the computer when the user detecting section detects that the user gets in the vehicle after the unlocking detecting section detects that the door is unlocked; and
a power source switching section for stopping a power supply from the auxiliary battery and starting a power supply from the main power source when the ignition key detecting section detects that the ignition key is switched from OFF to ON during the power supply from the auxiliary battery.
